(19) United States
(12) Patent Application Publication
(10) Pub. No.: US 2014/0145502 A1
(43) Pub. Date: May 29, 2014

(54) VEHICLE POWER-SUPPLY SYSTEM AND CONTROL METHOD THEREOF

(71) Applicant: Yoshinobu SUGIYAMA, Toyota-shi (JP)

(72) Inventor: Yoshinobu SUGIYAMA, Toyota-shi (JP)

(73) Assignee: TOYOTA JIDOSHA KABUSHIKI KAISHA, Toyota-shi (JP)

(21) Appl. No.: 14/082,736

(22) Filed: Nov. 18, 2013

(30) Foreign Application Priority Data
Nov. 28, 2012 (JP) 2012-259454

(51) Int. Cl. B60L 11/18

(52) U.S. Cl. CPC B60L 11/1824
USPC 307/9.1

(57) ABSTRACT

A vehicle power-supply system includes a main power storage device that supplies power to a load circuit; a sub power storage device that outputs a voltage different from a voltage of the main power storage device and supplies power to an auxiliary device load circuit of the vehicle; a charging circuit that is connected between the main power storage device and the sub power storage device and charges the sub power storage device using power supplied from the main power storage device; and a control device that controls the charging circuit. The control device charges the sub power storage device via the charging circuit when a predetermined time elapses after a stop command for the vehicle power-supply system is entered, and stops the charging of the sub power storage device when a starting preparation for the vehicle power-supply system is detected.

### INCORPORATION BY REFERENCE

The disclosure of Japanese Patent Application No. 2012-259454 filed on Nov. 28, 2012 including the specification, drawings and abstract is incorporated herein by reference in its entirety.

### BACKGROUND OF THE INVENTION

1. Field of the Invention

The present invention relates to a vehicle power-supply system and its control method.

2. Description of Related Art

A vehicle is known that has two types of power storage device: a main power storage device (hereinafter called a main battery) and a sub power storage device (hereinafter called an auxiliary battery). The main battery supplies power to a main load circuit to which a driving-force generating motor is connected. The auxiliary battery supplies power to auxiliary devices such as a headlight or a car navigation device. (Japanese Patent Application Publication No. 2006-174619 (JP 2006-174619 A).

This type of vehicle has a relay device, provided between the main battery and the auxiliary battery, to switch the power supply between on and off states. For example, between the moment the ignition switch is switched from the on state to the off state and the moment the ignition switch is switched again to the on state and the vehicle is started, the relay device is turned on at regular intervals to perform charging control. This charging control charges the auxiliary battery, whose power storage amount is reduced by self-discharge over time, by power from the main battery, thereby recovering the auxiliary battery from the low voltage state.

However, a request to start the vehicle system, if issued by the user during the charging operation, requires time to shift from the charging control state to the vehicle-start control state, meaning that, as compared to the case in which a start request is received while the battery is not being charged, it will take longer to start the vehicle system.

### SUMMARY OF THE INVENTION

The present invention provides a vehicle power-supply system and its control method capable of charging an auxiliary battery during parking while reducing delays in starting a vehicle system.

A first aspect of the present invention relates to a vehicle power-supply system. The system includes: a main power storage device that supplies power to a load circuit; a sub power storage device that outputs a voltage different from a voltage of the main power storage device and supplies power to an auxiliary device load circuit of the vehicle; a charging circuit that charges the sub power storage device using power supplied from the main power storage device, the charging circuit connected between the main power storage device and the sub power storage device; and a control device that controls the charging circuit, wherein the control device charges the sub power storage device via the charging circuit when a predetermined time elapses after a stop command for the vehicle power-supply system is entered, and stops the charging of the sub power storage device when a starting preparation for the vehicle power-supply system is detected.

A second aspect of the present invention relates to a control method for use in a vehicle power-supply system including a main power storage device that supplies power to a load circuit; a sub power storage device that outputs a voltage different from a voltage of the main power storage device and supplies power to an auxiliary device load circuit of the vehicle; and a charging circuit that charges the sub power storage device using power supplied from the main power storage device, the charging circuit connected between the main power storage device and the sub power storage device. The control method includes: charging the sub power storage device via the charging circuit when a predetermined time elapses after a stop command for the vehicle power-supply system is entered; and stopping the charging of the sub power storage device when a starting preparation for the vehicle power-supply system is detected.

According to the configuration described above, the present invention stops charging during auxiliary charging as necessary while preventing an auxiliary battery from running out, thus reducing delays in starting a vehicle system.

### BRIEF DESCRIPTION OF THE DRAWINGS

Features, advantages, and technical and industrial significance of exemplary embodiments of the invention will be described below with reference to the accompanying drawings, in which like numerals denote like elements, and wherein:

FIG. 1 is a circuit diagram showing a configuration of a vehicle 1 on which a vehicle power-supply system is mounted;

FIG. 2 is a diagram showing a detailed configuration of a control device 30 in FIG. 1;

FIG. 3 is a flowchart showing the control of power-transfer charging performed by the control device 30; and

FIG. 4 is a flowchart showing the detail of the timer start condition setting processing in step S10 in FIG. 3.

### DETAILED DESCRIPTION OF EMBODIMENTS

An exemplary embodiment of the present invention is described in detail below with reference to the drawings. In the drawings, the same reference numeral is used to denote the same or equivalent element, and the further description of that element will be omitted.

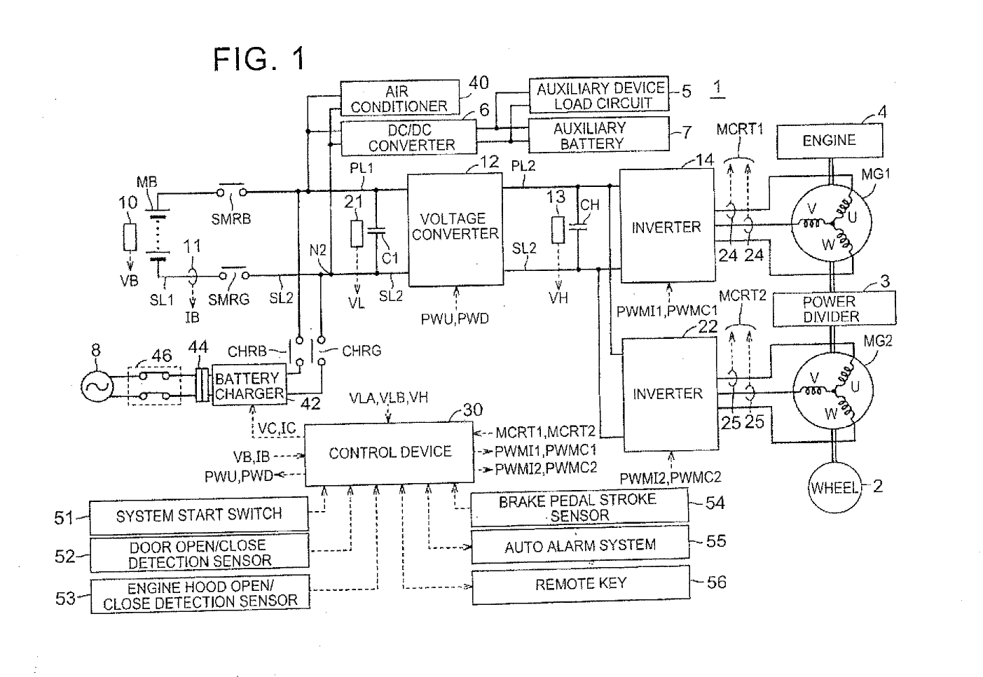

FIG. 1 is a circuit diagram showing the configuration of a vehicle 1 on which a vehicle power-supply system is mounted. Referring to FIG. 1, the vehicle 1 includes a main battery MB that is a power storage device, a voltage converter 12, smoothing capacitors C1 and CH, voltage sensors 10, 13, and 21, an air conditioner 40, an auxiliary device load circuit 5, a DC/DC converter 6, an auxiliary battery 7, inverters 14 and 22, an engine 4, motor generators MG1 and MG2, a power divider 3, a wheel 2, and a control device 30.

The vehicle power-supply system described in the exemplary embodiment further includes a positive electrode bus PL2 via which power is supplied to the inverter 14 that drives the motor generator MG2. The voltage converter 12, provided between the main battery MB and the positive electrode bus PL2, is a voltage converter that converts the voltage. The air conditioner 40 and the DC/DC converter 6 are connected, respectively, to a positive electrode bus PL1 and a negative electrode bus SL2. For example, a DC voltage of 14V is supplied from the DC/DC converter 6 to the auxiliary device load circuit 5 as the power supply voltage. In addition, a charging voltage is supplied from the DC/DC converter 6 to the auxiliary battery 7 for charging.

The smoothing capacitor C1 is connected between the positive electrode bus PL1 and the negative electrode bus SL2. The voltage sensor 21 detects a voltage VL across the ends of the smoothing capacitor C1 and outputs the detected voltage to the control device 30. The voltage converter 12 increases the voltage across the terminals of the smoothing capacitor C1.

The smoothing capacitor CH smoothes the voltage increased by the voltage converter 12. The voltage sensor 13 detects a voltage VH across the terminals of the smoothing capacitor CH and outputs the detected voltage to the control device 30.

The inverter 14 converts the DC voltage, received from the voltage converter 12, to a three-phase AC voltage and outputs the converted voltage to the motor generator MG1. The inverter 22 converts the DC voltage, received from the voltage converter 12, to a three-phase AC voltage and outputs the converted voltage to the motor generator MG2.

The power dividing mechanism 3, connected to the engine 4 and motor generators MG1 and MG2, distributes the power among those components. For example, a planetary gear mechanism, composed of three rotation axes (sun gear, planetary carrier, ring gear), may be used as the power dividing mechanism. In the planetary gear mechanism, when the rotations of two of the three rotation axes are determined, the rotation of the remaining one rotation axis is automatically determined depending upon the rotations of those two rotation axes. The three rotation axes are connected, respectively, to the rotation axes of the engine 4 and the motor generators MG1 and MG2. The rotation axis of the motor generator MG2 is connected to the wheel 2 via the reduction gear and the differential gear not shown. The power dividing mechanism 3 may further include therein a reducer for the rotation axis of the motor generator MG2.

The vehicle 1 further includes two system main relays: one is a system main relay SMRB connected between the positive electrode of the main battery MB and the positive electrode bus PL1, and the other is a system main relay SMRG connected between the negative electrode of the main battery MB (negative electrode bus SL1) and the node N2.

The electrical continuity of the system main relays SMRB and SMRG is controlled according to the control signal received from the control device 30.

The voltage sensor 10 measures a voltage VB across the terminals of the main battery MB. In addition to the voltage sensor 10, an electric current sensor 11, which detects an electric current IB flowing through the main battery MB, is provided to monitor the charging state of the main battery MB. As the main battery MB, a secondary battery such as a lead acid battery, a nickel-metal hydride battery, and a lithium ion battery or a large-capacity capacitor such as an electric double layer capacitor may be used. As will be described later, the negative electrode bus SL2 extends into the direction of the inverters 14 and 22 through the voltage converter 12.

The inverter 14 is connected to the positive electrode bus PL2 and the negative electrode bus SL2. Upon receiving an increased voltage from the voltage converter 12, the inverter 14 drives the motor generator MG1, for example, to start the engine 4. The inverter 14 also returns electric power, generated by the motor generator MG1 using power transmitted from the engine 4, to the voltage converter 12. At this time, the voltage converter 12 is controlled by the control device 30 so that the voltage converter 12 works as a voltage step-down circuit.

A current sensor 24 detects the current, which flows to the motor generator MG1, as a motor current value MCRT1 and outputs the motor current value MCRT1 to the control device 30.

The inverter 22, provided in parallel to the inverter 14, is connected to the positive electrode bus PL2 and the negative electrode bus SL2. The inverter 22 converts the DC voltage, output by the voltage converter 12, to a three-phase AC voltage and outputs the converted voltage to the motor generator MG2 that drives the wheel 2. When regenerative braking is performed, the inverter 22 returns electric power, generated by the motor generator MG2, to the voltage converter 12. At this time, the voltage converter 12 is controlled by the control device 30 so that the voltage converter 12 works as a voltage step-down circuit.

A current sensor 25 detects the current, which flows to the motor generator MG2, as a motor current value MCRT2 and outputs the motor current value MCRT2 to the control device 30.

The control device 30 receives the torque command values and the rotation speeds of the motor generators MG1 and MG2, the values of the electric current IB and the voltages VB, VL, and VH, the motor current values MCRT1 and MCRT2, and a start signal IGON. The control device 30 outputs three types of instruction signal to the voltage converter 12: the control signal PWU that steps up the voltage, the control signal PWD that steps down the voltage, and the shutdown signal that inhibits the operation.

In addition, the control device 30 outputs control signals PWMI1 and PWMC1 to the inverter 14. The control signal PWMI1 instructs the inverter 14 to convert the DC voltage, which is the output of the voltage converter 12, to an AC voltage for driving the motor generator MG1. The control signal PWMC1 instructs the inverter 14 to convert the AC voltage, generated by the motor generator MG1, to a DC voltage and return the regenerated DC voltage to the voltage converter 12.

Similarly, the control device 30 outputs control signals PWMI2 and PWMC2 to the inverter 22. The control signal PWMI2 instructs the inverter 22 to convert the DC voltage to an AC voltage for driving the motor generator MG2. The control signal PWMC2 instructs the inverter 22 to convert the AC voltage, generated by the motor generator MG2, to a DC voltage and return the regenerated DC voltage to the voltage converter 12.

The vehicle 1 further includes relays CHRB and CHRG used at charging time, a battery charger 42, and a connector 44. The connector 44 is connected to commercial power 8 via a charging circuit interrupt device (CCID) relay 46. The commercial power 8 is, for example, a 100V AC power supply.

The control device 30 sends the instructions (charging current IC and charging voltage VC) to the battery charger 42. The battery charger 42 converts AC power to DC power and, at the same time, adjusts the voltage and supplies the adjusted voltage to the battery. To allow the battery to be charged externally, another method may also be used. For example, the neutral point of the stator coils of the motor generators MG1 and MG2 may also be connected to the AC power supply.

The control device 30 receives signals from a system start switch 51, a door open/close detection sensor 52, an engine hood open/close detection sensor 53, a brake pedal stroke sensor 54, an auto alarm system 55, and a remote key 56 to determine the state of the vehicle.

To prevent the auxiliary battery 7 from running out while the vehicle is parking, the control device 30 causes the DC/DC converter 6 to operate to charge the auxiliary battery 7 from the main battery MB. Each time the parking state continues for a first predetermined time (for example, 10 days), the auxiliary battery 7 is automatically charged for a second predetermined time (for example, ten minutes). Note that the auxiliary battery 7 is charged as described above only when the state of charge (SOC) of the main battery MB is equal to or higher than a predetermined SOC (control based SOC).

In this way, the amount of electric energy discharged from the auxiliary battery 7 while the vehicle is parking (for example, amount of electric energy discharged during 10 days) is recharged from the main battery MB as necessary (for example, by charging for 10 minutes).

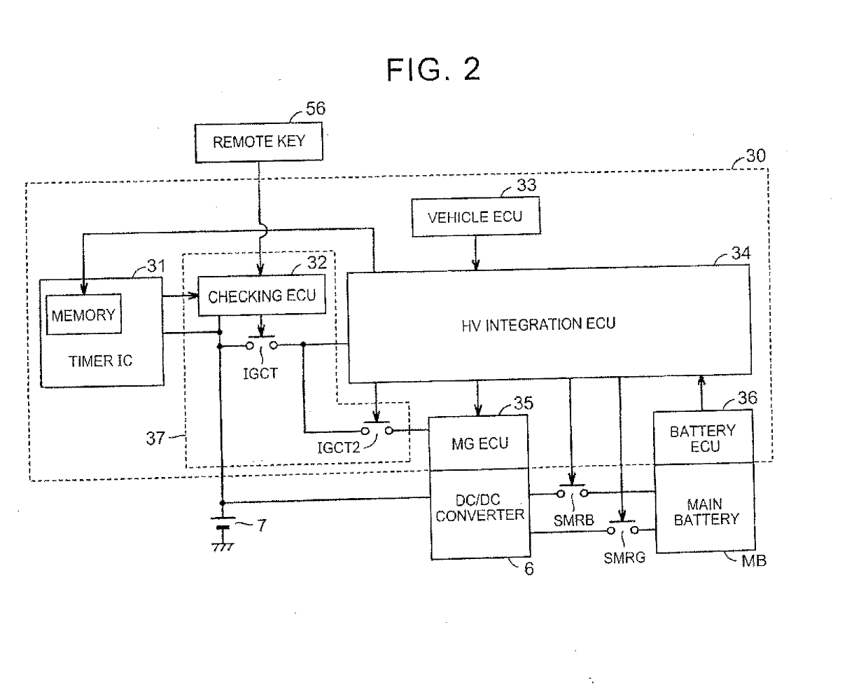

FIG. 2 is a diagram showing a detailed configuration of the control device 30 in FIG. 1. Referring to FIG. 2, the control device 30 includes a timer integrated circuit (IC) 31, a checking electronic control unit (ECU) 32, a vehicle ECU 33, an HIV integration ECU 34, an MG-ECU 35, a battery ECU 36, and switches IGCT and IGCT2.

The control device 30 receives the power-supply voltage from the auxiliary battery 7. Although constantly supplied to the timer IC 31 and the checking ECU 32, this power-supply voltage is supplied to the HIV integration ECU 34 and the MG-ECU 35, respectively, via the switch IGCT and the switch IGCT2. The switches IGCT and IGCT2 may be a mechanical switch, such as a relay, or a semiconductor device such as a transistor.

The checking ECU 32 and the switches IGCT and IGCT2 function as a power supply control unit 37 that controls the power supply to the HIV integration ECU 34 and the MG-ECU 35.

The checking ECU 32 checks if the signal from the remote key 56 matches the vehicle. If the checking result indicates a match, the checking ECU 32 turns on the switch IGCT to supply power to the HIV integration ECU 34 with the result that the HIV integration ECU 34 is started. In this case, the user can operate various operation units in the vehicle interior to run the vehicle.

The vehicle ECU 33 detects the vehicle state, including the state of the operation units (such as start switch) in the vehicle interior, and sends the detected vehicle state to the HIV integration ECU 34.

The battery ECU 36 monitors the current and the voltage of the main battery MB, detects the battery state including the charging state SOC, and sends the detected battery state to the HIV integration ECU 34.

Based on the vehicle state received from the vehicle ECU 33 and on the battery state received from the battery ECU 36, the HIV integration ECU 34 controls the system main relays SMRB and SMRG and the MG-ECU 35.

The MG-ECU 35 controls the DC/DC converter 6, as well as the inverters 14 and 22 and the voltage converter 12 shown in FIG. 1, under control of the HIV integration ECU 34. In many cases, the DC/DC converter 6 and the inverters 14 and 22 and the voltage converter 12, shown in FIG. 1, are arranged as a power control unit (PCU).

As described above, the auxiliary battery 7 plays an important role as the power supply for controlling the vehicle. This means that, when the auxiliary battery 7 runs out, the vehicle cannot be started. Therefore, when the vehicle is placed in the parking state, with the vehicle system left in the non-started state, for a long time, the auxiliary battery, whose battery storage amount is reduced by self-discharge over time, needs to be recovered.

To meet this requirement, the timer IC 31 outputs a start command to the checking ECU 32 when the first predetermine time, stored in the internal memory, has elapsed after the vehicle system is turned off through the operation of the system start switch 51 in FIG. 1.

In response to the start command from the timer IC 31, the checking ECU 32 turns on the switch IGCT even if no signal is received from the remote key 56. The switch IGCT, once turned on, supplies power to the HIV integration ECU 34 and, as a result, the HIV integration ECU 34 is started. In this case, if the SOC of the main battery MB is equal to or higher than a predetermined SOC, the HIV integration ECU 34 turns on the system main relays SMRB and SMRG and turns on the switch IGCT2, causing the MG-ECU 35 to perform power-transfer charging via the DC/DC converter 6. Charging performed by transferring electric power from the main battery MB to the auxiliary battery 7 in this manner is called power-transfer charging.

The HIV integration ECU 34 can rewrite the first predetermined time, stored in the memory of the timer IC 31, as necessary. The ability to rewrite the first predetermined time allows power-transfer charging to be performed so that the auxiliary battery 7 does not run out, for example, when charging is stopped halfway.

The configuration of the control device 30 shown in FIG. 2 is exemplary only and various modifications are possible. Although a plurality of ECUs is included in the control device 30 in FIG. 2, the ECUs may be configured by a fewer, more-integrated ECUs or, conversely, by more ECUs.

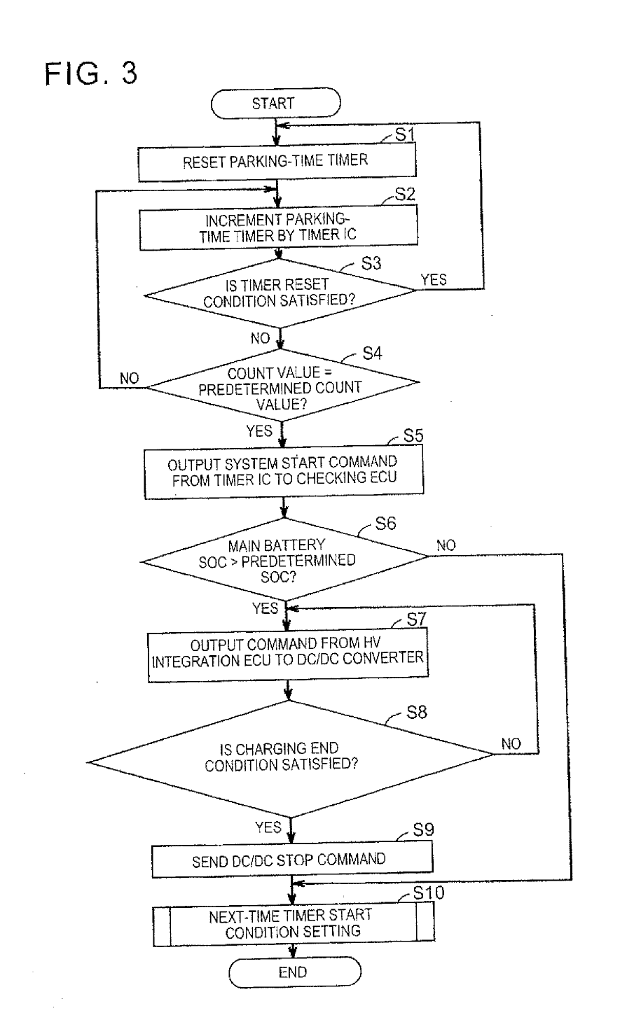

FIG. 3 is a flowchart showing the control of power-transfer charging performed by the control device 30. When the user turns off the system start switch (IG off), the processing shown in FIG. 3 is started. The following describes the processing with reference to FIG. 2 and FIG. 3. In step S1, the control device 30 resets the parking-time timer by which the timer IC 31 measures the parking time. For example, upon detecting an IG off condition, the HIV integration ECU 34 causes the timer IC 31 to reset the measurement value.

Next, in step S2, the timer IC 31 increments the parking-time timer to measure the parking time. In step S3, the control device 30 determines whether the timer reset condition is satisfied.

The timer reset condition is satisfied, for example, when the system start switch 51 shown in FIG. 1 is operated to shift the vehicle system to the on (IG on) state or when the connector 44 is connected to the vehicle to start external charging. If the timer reset condition is satisfied in step S3, the processing returns to step S1 to reset the parking-time timer of the timer IC 31.

If the timer reset condition is not satisfied in step S3, the processing proceeds to step S4. In step S4, the control device 30 determines whether the value of the parking-time timer (hereinafter called a count value), incremented by the timer IC 31, is equal to (or exceeds) a predetermined count value (a value corresponding to first predetermined time, for example, ten days) stored in the memory. That is, in step S4, the control device 30 determines whether the vehicle is left unused in the parking state for the first predetermined time (for example, ten days).

If the count value does not reach the predetermined count value in step S4, the processing returns to step S2 to continue incrementing the parking-time timer. On the other hand, if the count value is equal to (or exceeds) the predetermined count value in step S4, the processing proceeds to step S5.

In step S5, the timer IC 31 outputs a system start command to the checking ECU 32. In response to this command, the checking ECU 32 turns on the switches IGCT and IGCT2. When these switches are turned on, the HIV integration ECU 34 and the MG-ECU 35 are started.

In step S6, the HIV integration ECU 34 determines whether the SOC of the main battery MB is larger than the predetermined SOC. The predetermined SOC may be set, for example, to the control central value of the SOC. The SOC of the main battery MB is managed so that it is in the range from the upper limit value (for example, 80%) to the lower limit value (for example, 40%), and the SOC control central value refers to the central value (for example, 60%) of this range. If the SOC is higher than the control central value, the main battery MB is considered to have power large enough to supply power from the main battery MB to the auxiliary battery 7.

If the SOC of the main battery MB is larger than the predetermined SOC in step S6, the processing proceeds to step S7. If the condition is not satisfied, the processing proceeds to step S10.

In step S7, the HIV integration ECU 34 outputs a command to the DC/DC converter 6 via the MG-ECU 35 to request the DC/DC converter 6 to perform power-transfer charging for the auxiliary battery 7. Before this command is output, the HIV integration ECU 34 turns on the system main relays SMRB and SMRG to connect the main battery MB and the DC/DC converter 6.

Next, in step S8, the HIV integration ECU 34 determines whether the charging end condition is satisfied. The charging end condition refers to one of the following conditions: a door of the vehicle is opened, the charging time of power-transfer charging continues for the second predetermined time (for example, ten minutes) or longer, or the SOC of the main battery MB falls below the predetermined SOC. Note that the second predetermined time (for example, ten minutes) is determined depending upon the predetermined count value used in step S4 (a value corresponding to first predetermined time, for example, ten days). For example, when ten minutes is long enough to compensate for a self-discharge for ten days, the second predetermined time of ten minutes is set for the predetermined count value often days.

In the above description, the charging end condition is generated, for example, when a door is opened. The charging end condition may also be generated when the engine hood is opened, the door lock is released, the brake pedal is operated, the auto alarm system enters the warning state, or the remote key is detected. In any of these situations, it is considered that the user touches the vehicle, the user is near the vehicle, or the user receiving the warning is approaching the vehicle. In any case, there is a high possibility that the user will start the vehicle system.

If the charging end condition is satisfied in step S8, the processing proceeds to step S9. If the charging end condition is not satisfied, the processing returns to step S7 to continue power-transfer charging.

In step S9, the HIV integration ECU 34 sends a command, which stops the DC/DC converter 6, to the MG-ECU 35. After step S9, the processing of step S10 is performed.

In step S10, the next-time timer start condition setting processing is performed. That is, when the power-transfer charging for the auxiliary battery 7 is stopped halfway or when the power-transfer charging is not started, the start time of the next power-transfer charging processing is set in order to prevent the auxiliary battery 7 from running out as much as possible. After the setting processing in step S10 is terminated, the processing of the flowchart in FIG. 3 is terminated.

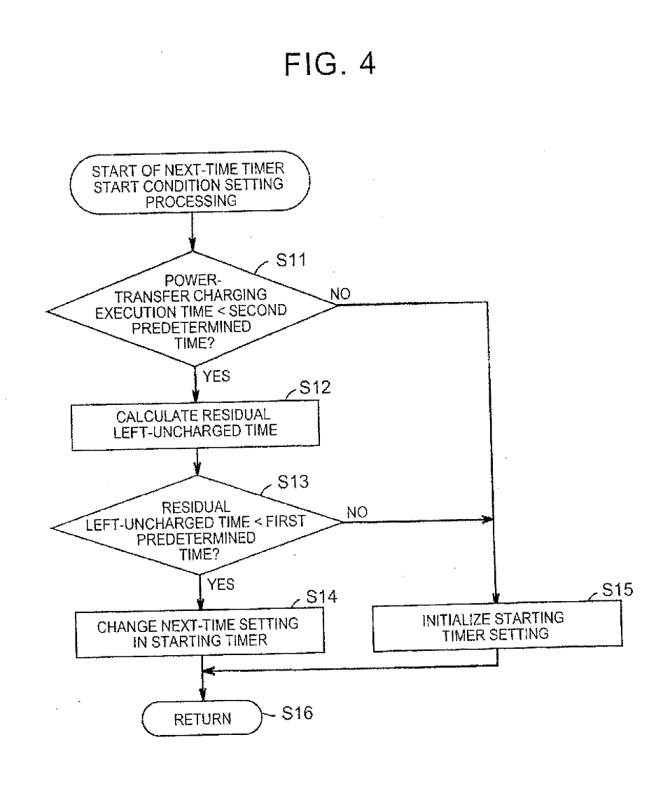

FIG. 4 is a flowchart showing the detail of the next-time timer start condition setting processing in step S10 in FIG. 3. When power-transfer charging is terminated halfway, the processing in this flowchart is performed to set a time, at which the next-time power-transfer charging will be performed, in order to prevent the auxiliary battery 7 from running out as much as possible.

The following describes the next-time timer start condition setting processing with reference to FIG. 2 and FIG. 4. In step S11, the control device 30 determines whether the power-transfer charging execution time, which is measured beginning at the same time the power-transfer charging was started, is shorter than the second predetermined time (for example, ten minutes). If the power-transfer charging execution time is equal to or longer than the second predetermined time (ten minutes) in step S11, the processing proceeds to step S15 to perform the usual processing. If the power-transfer charging execution time is shorter than the second predetermined time (ten minutes) in step S11, the battery is not yet charged as scheduled. In this case, the processing proceeds to step S12.

In step S12, the control device 30 calculates a residual left-uncharged time for which the auxiliary battery 7 may be left uncharged (a remaining time until the auxiliary battery 7 without being charged by power-transfer charging runs out). An example of calculating this residual left-uncharged time in terms of the number of days is as follows. For example, the residual left-uncharged time is calculated by subtracting the number of consecutive days of parking from a constant. The constant is the number of days (for example, 100 days) for which the auxiliary battery 7 is alive without being charged by power-transfer charging, beginning on the day on which the auxiliary battery 7 is fully charged.

When the vehicle is started, the DC/DC converter 6 normally charges the auxiliary battery 7 to its full capacity. Therefore, when the processing of the flowchart in FIG. 3 is started, the auxiliary battery 7 is fully charged in many cases.

Note that, when power-transfer charging is stopped halfway, the number of consecutive days of parking used in the processing in step S12 is not reset to zero but continued to be incremented. For example, when power-transfer charging is performed ten days after the start of parking and, before ten-minute charging is completed, the charging is stopped for some reason (for example, a door is opened), the number of consecutive days of parking on the following day is 11.

When power-transfer charging is stopped because a door is opened and, after that, the vehicle is started for traveling, the number of consecutive days of parking is initialized to zero. In this case, the auxiliary battery 7 is charged to its full capacity during the travel.

Next, in step S13, the control device 30 determines whether the residual left-uncharged time, calculated in step S12, is shorter than the first predetermined time (for example, ten days) used in step S4 in FIG. 3. If the residual left-uncharged time is equal to or longer than the first predetermined time, the processing proceeds to step S15.

In step S15, the setting of the starting timer is initialized and the predetermined count value, used in step S4 in FIG. 3, is set to the initial value (for example, ten days). Therefore, as long as the number of residual left-uncharged days is equal to or longer than the first predetermined time, power-transfer charging is performed at an interval (for example, ten days) corresponding to the first predetermined time.

On the other hand, if the residual left-uncharged time is shorter than the first predetermined time in step S13, the processing proceeds to step S14. In step S14, the timer setting value for detecting the arrival of the next start time is changed. More specifically, because the residual left-uncharged time is determined to be shorter than the first predetermined time in step S13, the auxiliary battery 7 will run out unless power-transfer charging is performed within the number of days equal to or smaller than the first predetermined time. Therefore, in step S14, the predetermined count value, used in step S4 in FIG. 3, is set to a value corresponding to the number of days shorter than the residual left-uncharged time. More specifically, when the residual left-uncharged time is eight days that is shorter than the first predetermined time (ten days), the predetermined count value in step S4 is rewritten to a value corresponding to the number of days equal to or smaller than eight days (for example, seven days).

After the next-time setting in the starting timer is changed in step S14 or the starting timer is initialized in step S15, the processing proceeds to step S16 and then control returns to the flowchart in FIG. 3. In this case, the processing is performed again, beginning in step S1 in FIG. 3. In step S4, the predetermined count value updated in step S14 or the predetermined count value initialized in step S15 is used.

[Modification] In FIG. 4, the residual left-uncharged time is calculated and, if the residual left-uncharged time is longer than the first predetermined time (for example, ten days), the time at which power-transfer charging will be performed next is set to the number of days ahead (for example, ten days ahead) corresponding to the first predetermined time and, if the residual left-uncharged time is shorter than the first predetermined time, the next start time is set equal to or smaller than the number of days corresponding to the residual left-uncharged time.

In this case, if the power-transfer charging execution time (second predetermined time) is determined corresponding to the first predetermined time, the next starting time may be determined based on the charging elapsed time during which power-transfer charging is actually performed. This prevents the auxiliary battery from running out without having to calculate the residual left-uncharged time.

More specifically, if power-transfer charging, which should be performed for ten minutes, can be performed only for five minutes, the starting time of the next power-transfer charging should be set to five days ahead, the half of ten days. That is, if charging is stopped when charging time is X % where ten minutes of charging time is 100%, the processing in FIG. 4 may be modified so that power-transfer charging is performed the number of days ahead corresponding to X % of ten days. The starting time of the next power-transfer charging may be determined by evaluating the charging progress based, not on the charging time, but on the SOC of the auxiliary battery 7.

Finally, this exemplary embodiment is generally described again with reference to the drawings. Referring to FIG. 1 and FIG. 2, the vehicle power-supply system in this exemplary embodiment includes the main battery MB that supplies power to the load circuit, the auxiliary battery 7 that outputs a voltage, different from that of the main battery MB, and supplies power to the auxiliary device load circuit 5 of the vehicle, the DC/DC converter 6 that is connected between the main battery MB and the auxiliary battery 7 and charges the auxiliary battery 7 using the power supplied from the main battery MB, and the control device 30 that controls the DC/DC converter 6. The control device 30 charges the auxiliary battery 7 via the DC/DC converter 6 when the first predetermined time elapses after the stop command for the power system of the vehicle is entered. The control device 30 stops the charging of the auxiliary battery 7 when a starting preparation for the power system of the vehicle is detected.

As a starting preparation, the control device 30 may detect one of the following conditions: a door is opened, the engine hood is opened, the door lock is released, the brake pedal is operated, the auto alarm system 55 enters the warning state, and the remote key 56 is detected.

As shown in FIG. 4, when the charging of the auxiliary battery 7 is stopped based on the detection of a starting preparation (YES in step S11), the control device 30 may calculate a time, for which the auxiliary battery 7 does not run out without being charged, as a residual left-uncharged time in step S12 and set the next-time charging start time of the auxiliary battery 7 based on the comparison between the residual left-uncharged time and the first predetermined time in step S13. In this case, the control device 30 may set the next-time charging start time of the auxiliary battery 7 to the first predetermined time ahead when the residual left-uncharged time is equal to or longer than the first predetermined time and set the next-time charging start time of the auxiliary battery 7 to a time before the residual left-uncharged time elapses when the residual left-uncharged time is shorter than the first predetermined time.

As described in the modification, when the charging of the auxiliary battery 7 is stopped based on the detection of a starting preparation after starting the charging of the auxiliary battery 7, the control device 30 may make the first predetermined time shorter than the initial value (for example, ten days) based on the charging elapsed time from the start to the stop of charging (time during which power-transfer charging is actually performed).

The embodiments disclosed herein are to be considered merely illustrative and not restrictive in any respect. The scope of the present invention is defined not by the foregoing description but by the appended claims, and it is intended that the scope of the present invention include all modifications that fall within the meaning and scope equivalent to those of the appended claims.

What is claimed is:

1. A vehicle power-supply system comprising:
a main power storage device that supplies power to a load circuit;
a sub power storage device that outputs a voltage different from a voltage of the main power storage device and supplies power to an auxiliary device load circuit of the vehicle;
a charging circuit that charges the sub power storage device using power supplied from the main power storage device, the charging circuit connected between the main power storage device and the sub power storage device; and
a control device that controls the charging circuit, wherein the control device charges the sub power storage device via the charging circuit when a predetermined time elapses after a stop command for the vehicle power-supply system is entered, and stops the charging of the sub power storage device when a starting preparation for the vehicle power-supply system is detected.

2. The vehicle power-supply system according to claim 1, wherein as the starting preparation, the control device detects at least one of conditions caused when a door is opened, an engine hood is opened, a door lock is released, a brake pedal is operated, an auto alarm system enters a warning state, and a remote key approaches the vehicle.

3. The vehicle power-supply system according to claim 1, wherein the control device calculates a time, for which a battery of the sub power storage device does not run out without being charged, as a residual left-uncharged time when the charging of the sub power storage device is stopped upon detection of the starting preparation and sets a next-time charging start time of the sub power storage device based on a comparison between the residual left-uncharged time and the predetermined time.

4. The vehicle power-supply system according to claim 3, wherein when the charging of the sub power storage device is stopped upon detection of the starting preparation, the control device sets the next-time charging start time of the sub power storage device to a time after the predetermined time elapses if the residual left-uncharged time is equal to or longer than the predetermined time, and sets the next-time charging start time of the sub power storage device to a time before the residual left-uncharged time elapses if the residual left-uncharged time is shorter than the predetermined time.

5. The vehicle power-supply system according to claim 1, wherein the control device makes the predetermined time shorter based on a charging elapsed time from a charging start to a charging stop when the charging of the sub power storage device is stopped upon detection of the starting preparation after the charging of the sub power storage device is started.

6. A control method for use in a vehicle power-supply system including a main power storage device that supplies power to a load circuit; a sub power storage device that outputs a voltage different from a voltage of the main power storage device and supplies power to an auxiliary device load circuit of the vehicle; and a charging circuit that charges the sub power storage device using power supplied from the main power storage device, the charging circuit connected between the main power storage device and the sub power storage device, the control method comprising:
charging the sub power storage device via the charging circuit when a predetermined time elapses after a stop command for the vehicle power-supply system is entered; and
stopping the charging of the sub power storage device when a starting preparation for the vehicle power-supply system is detected.
